(19) United States
(12) Patent Application Publication
(10) Pub. No.: US 2018/0002136 A1
(43) Pub. Date: Jan. 4, 2018

(54) METHOD FOR CLEANING SEPARATOR CORE, SEPARATOR ROLL, AND METHOD FOR PRODUCING SEPARATOR ROLL

(71) Applicant: Sumitomo Chemical Company, Limited, Tokyo (JP)

(72) Inventors: Taro NOMURA, Niihama-shi (JP); Daizaburo YASHIKI, Niihama-shi (JP); Satoshi YONEYAMA, Niihama-shi (JP)

(21) Appl. No.: 15/637,342

(22) Filed: Jun. 29, 2017

(30) Foreign Application Priority Data
Jun. 30, 2016 (JP) 2016-130288
Dec. 23, 2016 (JP) 2016-250240

(51) Int. Cl. B65H 75/10; H01M 2/16; H01M 2/14; H01M 2/18; C08J 5/22

(52) U.S. Cl. CPC B65H 75/10; H01M 2/18; C08J 5/2206; H01M 2/145; H01M 2/1653

(57) ABSTRACT

A method for cleaning a separator core in accordance with an embodiment of the present invention is a method for cleaning a separator core having an outer peripheral surface around which a separator is to be wound, the method including: an end face cleaning step of removing a foreign object adhered to an end face of the separator core.

This Nonprovisional application claims priority under 35 U.S.C. §119 on Patent Application No. 2016-250240 filed in Japan on Dec. 23, 2016, and on Patent Application No. 2016-130288 filed in Japan on Jun. 30, 2016, the entire contents of both of which are hereby incorporated by reference.

### TECHNICAL FIELD

The present invention relates to (i) a method for cleaning a separator core which is used in winding a separator for a nonaqueous electrolyte secondary battery (hereinafter referred to as a “nonaqueous electrolyte secondary battery separator”), (ii) a separator roll, and (iii) a method for producing the separator roll.

### BACKGROUND ART

Patent Literature 1 discloses an example of a separator core around which a separator is wound when being provided as a product, the separator having been produced continuously while being transferred via a transfer system such as a roller. The separator produced thusly is provided as a separator roll wound around an outer peripheral surface of the separator core.

### CITATION LIST

### Patent Literature

[Patent Literature 1]

Japanese Patent Application Publication Tokukai No. 2013-139340 (Publication date: Jul. 18, 2013)

### SUMMARY OF INVENTION

### Technical Problem

In a separator core which has been used and from which a separator has been wound off, there are cases in which a foreign object, such as an electrically conductive foreign object, is adhered to the separator core. If the separator core having such a foreign object adhered thereto is reused as is, the foreign object can adhere to a separator to be wound around the separator core. This can cause a product defect such as a short circuit in a nonaqueous electrolyte secondary battery produced using the separator.

An embodiment of the present invention has been made in view of the above problem. An object of an embodiment of the present invention lies in preventing adherence of a foreign object to a separator, which adherence occurs in reuse of a separator core.

### Solution to Problem

In order to solve the above problem, a method for cleaning a separator core in accordance with an embodiment of the present invention is a method for cleaning a separator core having an outer peripheral surface around which a nonaqueous electrolyte secondary battery separator is to be wound, the method including: an end face cleaning step of removing a foreign object adhered to an end face of the separator core.

### Advantageous Effects of Invention

An embodiment of the present invention brings about the effect of providing (i) a method for cleaning a separator core, (ii) a separator roll, and (iii) a method for producing the separator roll, each of which makes it possible to prevent adherence of a foreign object to a separator, which adherence occurs in reuse of a separator core.

### BRIEF DESCRIPTION OF DRAWINGS

FIG. 1 is a diagram schematically illustrating a cross-sectional configuration of a lithium-ion secondary battery in accordance with Embodiment 1.

FIG. 2 provides diagrams schematically illustrating various states of the lithium-ion secondary battery illustrated in FIG. 1.

FIG. 3 provides diagrams schematically illustrating various states of a lithium-ion secondary battery having another configuration.

FIG. 4 is a diagram schematically illustrating an example of a winding step in which a separator which has been slit is wound around a core.

(a) of FIG. 5 is a side view of a core around which a heat-resistant separator is to be wound. (b) of FIG. 5 is a side view of an example of a separator roll in which a separator has been wound around the core illustrated in (a) of FIG. 5.

FIG. 6 is a flow chart schematically showing a method for cleaning a core that has been used.

FIG. 7 is a schematic diagram for explaining a label removal step as shown in FIG. 6.

FIG. 8 is a schematic diagram for explaining an outer peripheral surface cleaning step as shown in FIG. 6.

FIG. 9 is a schematic diagram for explaining an end face cleaning step as shown in FIG. 6.

FIG. 10 is a flow chart schematically showing a method for producing a separator roll in accordance with Embodiment 2.

### DESCRIPTION OF EMBODIMENTS

### Embodiment 1

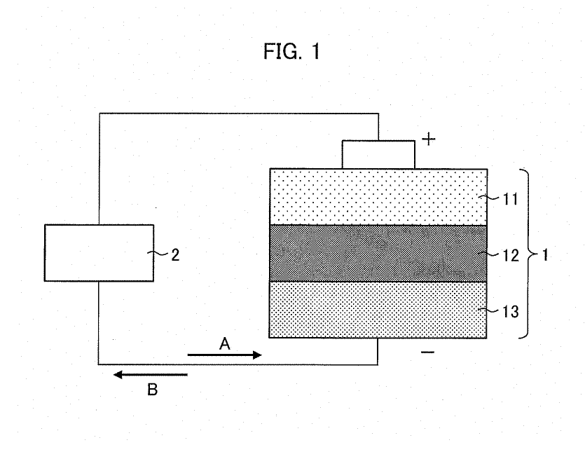

The following description will discuss an embodiment of the present invention with reference to FIGS. 1 through 9. Discussed in Embodiment 1 is an example of a method for cleaning a separator core which separator core is used in winding a nonaqueous electrolyte secondary battery separator.

Note that in the present specification, “cleaning” refers to an operation performed to remove foreign objects from a separator core. In other words, the term “cleaning” as used in the present specification is not limited to an operation to remove foreign objects from a separator core by use of a cleaning liquid, but rather includes any of various types of operations for removing foreign objects from a separator core, such as (i) removing foreign objects from a separator core by scouring off the foreign objects and (ii) removing foreign objects from a separator core by wiping the separator core.

Discussed first is a lithium-ion secondary battery (nonaqueous electrolyte secondary battery) including a nonaqueous electrolyte secondary battery separator (hereinafter also referred to as a “separator”) which had been wound around the separator core in accordance with Embodiment 1.

<Configuration of Lithium-Ion Secondary Battery>

The following description will discuss a configuration of a lithium-ion secondary battery with reference to FIGS. 1 to 3. A nonaqueous electrolyte secondary battery, typically, a lithium-ion secondary battery has a high energy density, and therefore, is currently widely used not only as batteries for use in devices such as personal computers, mobile phones, and mobile information terminals, and for use in moving bodies such as automobiles and airplanes, but also as stationary batteries contributing to stable power supply.

FIG. 1 is a diagram schematically illustrating a cross sectional configuration of a lithium-ion secondary battery 1. As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

<Separator>

The separator 12 is provided so as to be sandwiched between the cathode 11 which is a positive electrode of the lithium-ion secondary battery 1 and the anode 13 which is a negative electrode of the lithium-ion secondary battery 1. The separator 12 separates the cathode 11 and the anode 13, allowing lithium ions to move between the cathode 11 and the anode 13. For example, polyolefin such as polyethylene or polypropylene is used as a material of the separator 12.

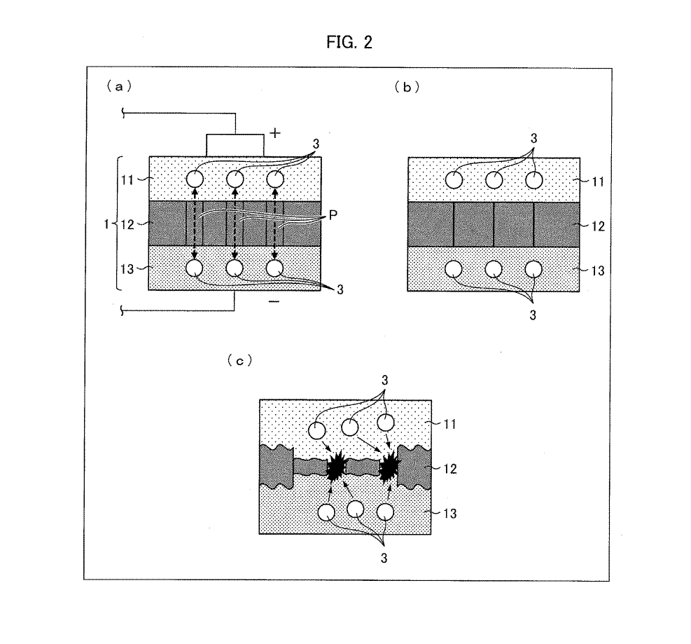

FIG. 2 provides diagrams schematically illustrating various states of the lithium-ion secondary battery 1 illustrated in FIG. 1. (a) of FIG. 2 illustrates a normal state. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device 2, or the like. In such cases, the separator 12 melts or softens and the pores P are blocked as illustrated in (b) of FIG. 2. As a result, the separator 12 shrinks. This stops the back-and-forth movement of the lithium ions 3, and consequently stops the above temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving back and forth. Consequently, the temperature continues rising.

<Heat-Resistant Separator>

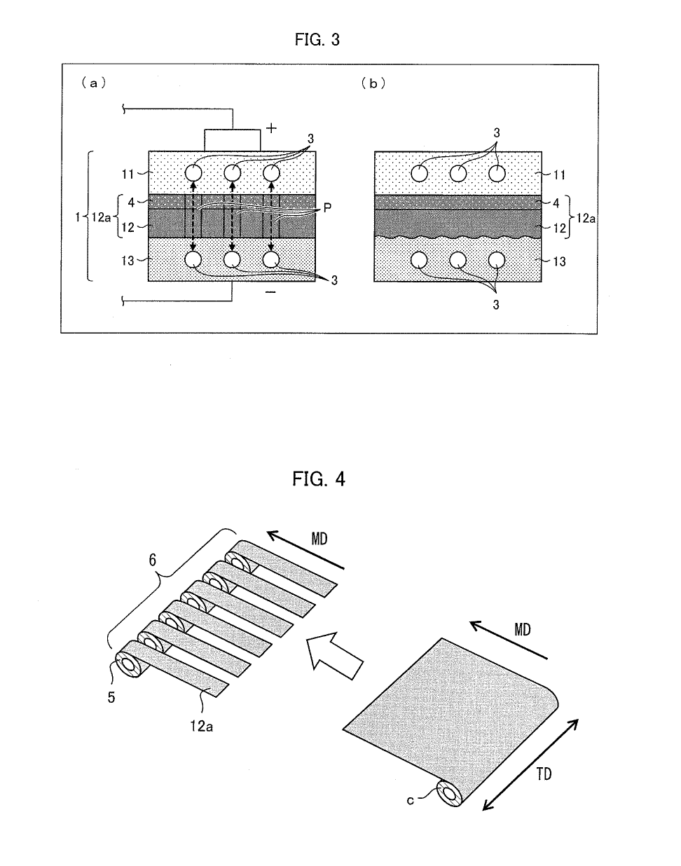

FIG. 3 provides diagrams schematically illustrating various states of a lithium-ion secondary battery 1 having another configuration. (a) of FIG. 3 illustrates a normal state, and (b) of FIG. 3 illustrates a state in which a temperature of the lithium-ion secondary battery 1 has sharply risen.

As illustrated in (a) of FIG. 3, the lithium-ion secondary battery 1 can further include a heat-resistant layer 4. The heat-resistant layer 4 can be provided to the separator 12. (a) of FIG. 3 illustrates a configuration in which the separator 12 is provided with the heat-resistant layer 4 serving as a functional layer. A film in which the separator 12 is provided with the heat-resistant layer 4 is an example of a separator having a functional layer and is hereinafter referred to as a heat-resistant separator (film) 12a. In the separator having a functional layer, the separator 12 serves as a base material for the functional layer.

In the configuration illustrated in (a) of FIG. 3, the heat-resistant layer 4 is disposed on a surface of the separator 12 which surface is on a cathode 11 side. Note that the heat-resistant layer 4 can alternatively be disposed on a surface of the separator 12 which surface is on an anode 13 side, or both surfaces of the separator 12. Further, the heat-resistant layer 4 is provided with pores which are similar to the pores P. Normally, the lithium ions 3 move back and forth through the pores P and the pores of the heat-resistant layer 4. The heat-resistant layer 4 contains, for example, wholly aromatic polyamide (aramid resin) as a material.

As illustrated in (b) of FIG. 3, even in a case where the temperature of the lithium-ion secondary battery 1 sharply rises and as a result, the separator 12 melts or softens, the shape of the separator 12 is maintained because the heat-resistant layer 4 supports the separator 12. Therefore, such a sharp temperature rise results in only melting or softening of the separator 12 and consequent blocking of the pores P. This stops the back-and-forth movement of the lithium ions 3 and consequently stops the above-described excessive discharging or excessive charging. In this way, the separator 12 can be prevented from being destroyed.

<Steps of Producing Separator and Heat-Resistant Separator>

How to produce the separator 12 and the heat-resistant separator 12a of the lithium-ion secondary battery 1 is not particularly limited. The separator 12 and the heat-resistant separator 12a can be produced by a publicly known method. The following discussion assumes a case where a porous film serving as a raw material of the separator 12 (heat-resistant separator 12a) contains polyethylene as a main material. Note, however, that even in a case where the porous film contains another material, the separator 12 (heat-resistant separator 12a) can be produced by employing a similar production method.

Examples of such a similar production method encompass a method which includes the steps of forming a film by adding inorganic filler or a plasticizer to a thermoplastic resin, and then removing the inorganic filler or the plasticizer by means of an appropriate solvent. For example, in a case where the porous film is a polyolefin separator made of a polyethylene resin containing ultra-high molecular weight polyethylene, it is possible to produce the porous film by the following method.

This method includes (1) a kneading step of obtaining a polyethylene resin composition by kneading a ultra-high molecular weight polyethylene with (i) an inorganic filler (such as calcium carbonate or silica) or (ii) a plasticizer (such as low molecular weight polyolefin or fluid paraffin), (2) a rolling step of forming a film by means of the polyethylene resin composition, (3) a removal step of removing the inorganic filler or the plasticizer from the film obtained in the step (2), and (4) a stretching step of obtaining the porous film by stretching the film obtained in the step (3). The step (4) can be alternatively carried out between the steps (2) and (3).

In the removal step, many fine pores are formed in the film. The fine pores of the film stretched in the stretching step serve as the above-described pores P. The porous film (separator 12) is thus obtained. Note that the porous film is a polyethylene microporous film having a prescribed thickness and a prescribed air permeability.

Note that, in the kneading step, (i) 100 parts by weight of the ultra-high molecular weight polyethylene, (ii) 5 parts by weight to 200 parts by weight of a low molecular weight polyolefin having a weight-average molecular weight of 10000 or less, and (iii) 100 parts by weight to 400 parts by weight of the inorganic filler can be kneaded.

The heat-resistant separator 12a can be produced by disposing the heat-resistant layer 4, as a functional layer, on a surface of the separator 12 obtained as above. The functional layer is disposed on the separator 12 by (i) coating the separator 12 with a coating material (a material) corresponding to the functional layer and then (ii) drying the separator 12. Note that production of the heat-resistant separator 12a is discussed in detail in Embodiment 2, in a section discussing a method for producing a separator roll.

The separator 12, which does not include the heat-resistant layer 4, and the heat-resistant separator 12a (hereinafter also referred to as “separator”) each preferably has a width (hereinafter referred to as “product width”) suitable for application products such as the lithium-ion secondary battery 1. For improved productivity, however, a separator is produced so as to have a width that is equal to or greater than a product width. Then, after having been once produced so as to have a width equal to or larger than the product width, the separator is cut (slit) so as to have the product width and wound around a core (separator core).

Note that the expression “width of a/the separator” means a dimension of the separator in a direction that is parallel to a plane in which the separator extends and that is perpendicular to the longitudinal direction of the separator. Hereinafter, a wide separator which has not been subjected to slitting is also referred to as an “original sheet.” Note also that (i) “slitting” means to slit the separator in the longitudinal direction (flow direction of the separator during production; MD: Machine direction) and (ii) “cutting” means to slit the separator in a transverse direction (TD). Furthermore, “transverse direction (TD)” means a direction that is parallel to a plane in which the separator extends and that is substantially perpendicular to the longitudinal direction (MD) of the separator.

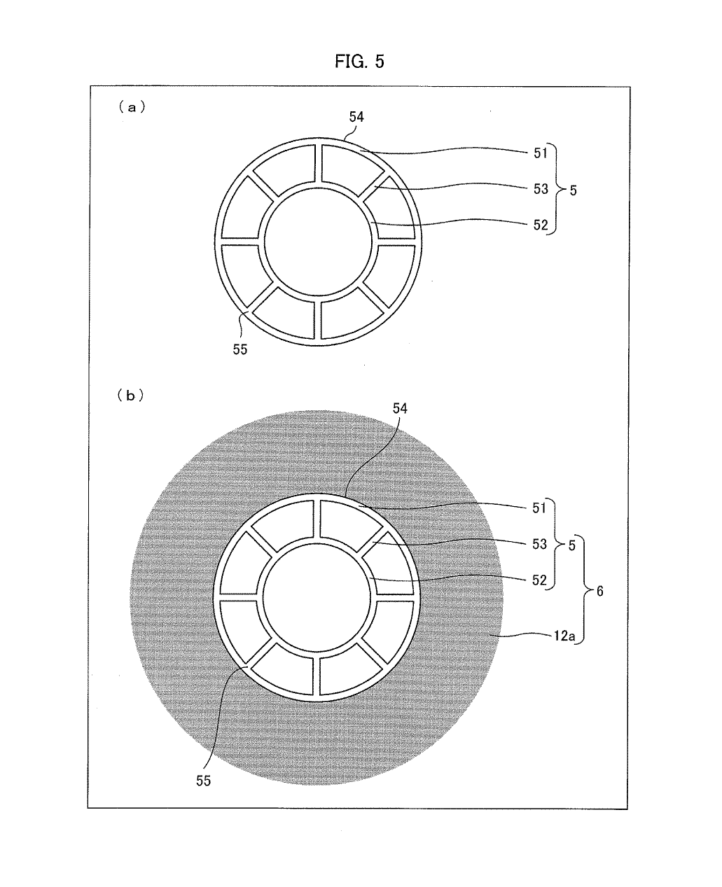

FIG. 4 is a diagram schematically illustrating an example of a winding step in which a heat-resistant separator 12a which has been slit is wound around a core 5. As illustrated in FIG. 4, an original sheet of the heat-resistant separator 12a, being transferred in the machine direction, is slit so as to be divided into a plurality of heat-resistant separators 12a having a predetermined product width. The plurality of the heat-resistant separators 12a are each wound around a respective core (separator core) 5 having a cylindrical shape. Note that a combination of (i) a separator (separator 12 or heat-resistant separator 12a) wound into a roll form and (ii) the core 5 is referred to as a separator roll 6.

<Structure of Core>

The following description will discuss a configuration of the core 5 with reference to FIG. 5. (a) of FIG. 5 is a side view of the core 5 in accordance with Embodiment 1. (b) of FIG. 5 is a side view of an example of a separator roll 6 in which a separator has been wound around the core 5 illustrated in (a) of FIG. 5. Note that (b) of FIG. 5 illustrates an example in which the separator roll 6 is constituted by the heat-resistant separator 12a wound around the core 5.

As illustrated in (a) of FIG. 5, the core 5 includes an outer cylindrical member 51, an inner cylindrical member 52, and a plurality of ribs 53. The inner cylindrical member 52 is provided inward of the outer cylindrical member 51 and functions as a bearing that fits onto an axis, such as a wind-up roller, around which the core 5 is caused to rotate. Each of the ribs 53 extends between the outer cylindrical member 51 and the inner cylindrical member 52 in a diametral direction and serves as a supporting member connecting the two. In Embodiment 1, the ribs 53 are provided so as to have equal intervals therebetween, at respective positions dividing the circumference of the core into eight equal portions. Each of the ribs 53 is provided so as to be substantially perpendicular to both the outer cylindrical member 51 and the inner cylindrical member 52. Note that the number of ribs 53 and the placement interval of the ribs 53 are not limited to the above configuration.

The respective central axes of the outer cylindrical member 51 and the inner cylindrical member 52 preferably substantially match each other but are not limited to such a configuration. Furthermore, dimensions of the outer cylindrical member 51 and the inner cylindrical member 52, such as the respective thicknesses, widths, and radii thereof, can be designed as necessary in accordance with, for example, the type of separator to be wound.

With regards to a material of the core 5, a resin containing any of ABS resin, polyethylene resin, polypropylene resin, polystyrene resin, polyester resin, and a vinyl chloride resin can be suitably used. This makes it possible to produce the core 5 by resin molding which uses a metal mold.

As illustrated in (b) of FIG. 5, the separator roll 6 is constituted by a separator roll (in the example of (b) of FIG. 5, the heat-resistant separator 12a) that has been slit into the product width and wound into the form of a roll around an outer peripheral surface 54 of the core 5 (that is, around an outer peripheral surface of the outer cylindrical member 51).

<Problems when Reusing Core>

Once the core 5 has been used and the separator wound off from the separator roll 6, there are cases in which a foreign object, such as an electrically conductive foreign object, is adhered to the core 5. Such a foreign object is particularly likely to adhere to end faces 55 of the core 5 (that is, to side faces of the core 5 which face away from each other in the axial direction). In a case where the core 5 has such a foreign object adhered thereto and is reused as is, the foreign object can adhere to a separator wound around the core 5. This can cause a product defect such as a short circuit in a lithium-ion secondary battery 1 produced using the separator.

Furthermore, since a cutter or the like may be used when cutting the separator off from the core 5, there is the risk that the outer peripheral surface 54 of the core 5 will be damaged. In a case where the core 5 having such damage is reused as is, unevenness caused by the damage can cause damage to a new separator wound around the core 5. This can cause a product defect such as a short circuit in a lithium-ion secondary battery 1 produced using the separator.

In this way, if the core 5, after having been used, is reused as is, there is the risk that a foreign object will adhere to a separator and the risk that the separator will be damaged. In Embodiment 1, such adherence of a foreign object to the separator and damage to the separator is prevented by cleaning the core 5 after it has been used.

<Method for Cleaning Core>

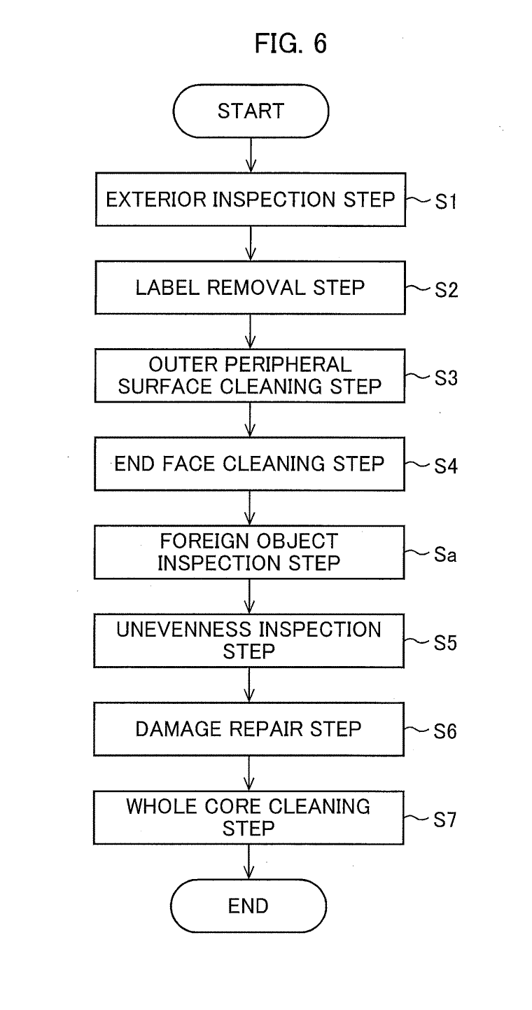

FIG. 6 is a flow chart schematically showing a method for cleaning the core 5 after it has been used. The method includes an exterior inspection step S1, a label removal step S2, an outer peripheral surface cleaning step S3, an end face cleaning step S4, a foreign object inspection step Sa, an unevenness inspection step S5, a damage repair step S6, and a whole core cleaning step S7. Each of the steps S1 through S7 will be discussed below in the above order. The order of the steps is, however, not limited to this order.

(Exterior Inspection Step)

The exterior inspection step S1 is a step of inspecting the core 5 that has been used, in order to determine whether or not the core 5 has a defect. In the exterior inspection step S1, the core 5, having been used, is screened by using a boundary sample as a standard and visually confirming whether or not the core 5 has a defect such as cracking or chipping. In a case where no defect such as cracking or chipping is found in the core 5 in the exterior inspection step S1, the core 5 is sent to the next step.

<Label Removal Step>

The label removal step S2 is step of removing a label (for example, a label indicating product information relating to a separator) which has been affixed to the core 5.

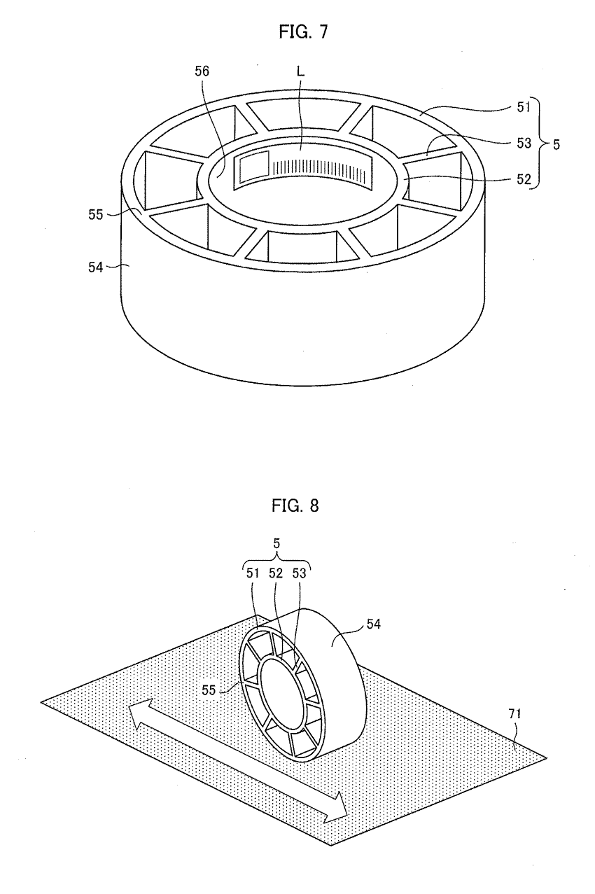

FIG. 7 is a schematic diagram for explaining the label removal step S2. As illustrated in FIG. 7, an inner peripheral surface 56 of the core 5 (an inner peripheral surface of the inner cylindrical member 52) usually has affixed thereto a label L, which indicates product information relating to a separator wound around the core 5. In the label removal step S2, the label L, which indicates, for example, product information relating to a separator which has been wound off, is removed, and the inner peripheral surface 56 of the core 5 is exposed.

(Outer Peripheral Surface Cleaning Step)

The outer peripheral surface cleaning step S3 is a step of cleaning the outer peripheral surface 54 of the core 5. After the core 5 is used, a foreign object, such as an aramid resin contained in the heat-resistant layer 4, may be adhered to the outer peripheral surface 54. It is preferable that such a foreign object adhered to the outer peripheral surface 54 of the core 5 be removed via the outer peripheral surface cleaning step S3.

FIG. 8 is a schematic diagram for explaining the outer peripheral surface cleaning step S3. As illustrated in FIG. 8, in the outer peripheral surface cleaning step S3, an adhesive sheet 71 having adhesiveness is provided, and the core 5 is rotated back and forth while the outer peripheral surface 54 of the core 5 is in contact with the adhesive sheet 71. This makes it possible to remove a foreign object adhered to the outer peripheral surface 54 of the core 5 by causing the foreign object to adhere to the adhesive sheet 71.

(End Face Cleaning Step)

The end face cleaning step S4 is a step of cleaning an end face 55 of the core 5. After the core 5 is used, a foreign object is particularly likely to be adhered to the end faces 55 of the core. Examples of such a foreign object include a cathode material (such as a lithium-based alloy) and an anode material (such as a graphite-based carbon material), each of which is used in production of a nonaqueous electrolyte secondary battery (lithium-ion secondary battery 1). It is preferable that such a foreign object adhered to an end face 55 of the core 5 be removed via the end face cleaning step S4.

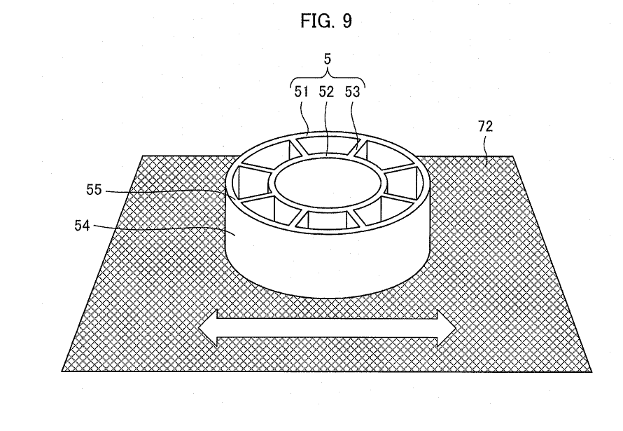

FIG. 9 is a schematic diagram for explaining the end face cleaning step S4. As illustrated in FIG. 9, in the end face cleaning step S4, a pressure-contact sheet (pressure-contact member) 72 is used to scour off a foreign object adhered to an end face 55 of the core 5. For example, the pressure-contact sheet 72 is provided, and the core 5 is moved parallel to the pressure-contact sheet 72 while an end face 55 of the core 5 is pressed into contact with the pressure-contact sheet 72. By performing this operation on both end faces 55 of the core 5, it is possible to use the pressure-contact sheet 72 to scour off and remove foreign objects adhered to the end faces 55 of the core 5.

It is preferable that a sheet having suitable elasticity and suitable frictional resistance is used as the pressure-contact sheet 72. For example, a resin foam sheet such as a vinyl chloride foam sheet can be suitably used as the pressure-contact sheet 72. It is preferable that the surface of the pressure-contact sheet 72 has asperities or a plurality of micropores. This makes it possible to improve the wiping effect of the pressure-contact sheet 72.

Furthermore, in the end face cleaning step S4, the pressure-contact sheet 72 can be used to wipe away a foreign object adhered to an end face 55 of the core 5 after carrying out a treatment, such as immersing the end face 55 of the core 5 into a solvent. This makes it possible to improve the effect of cleaning the end face 55 of the core 5.

An aprotic solvent is preferably used as the solvent. In a case where the core 5 is configured to include a material such as ABS resin, using alcohol as the solvent is likely to cause the core 5 deteriorate. An aprotic solvent can be used as the solvent to increase the effect of cleaning the end face 55 of the core 5 while also preventing deterioration of the core 5. A nonpolar solvent is preferably used as the aprotic solvent. For example, a hydrocarbon (such as decane) can be suitably used. In addition to being unlikely to cause deterioration of the core 5, such a nonpolar solvent is also preferable due to being volatile. This is because such volatility makes it unnecessary to carry out a step of drying the core 5 after cleaning.

A liquid obtained by adding a surfactant to water can also be used as the solvent. The liquid is preferably heated to a temperature of 40° C. to 90° C. prior to use, as doing so increases the effect of cleaning. The liquid is more preferably heated to a temperature of 50° C. to 70° C.

In the end face cleaning step S4, as an alternative to the method of using a pressure-contact member in the form of a sheet (that is, the pressure-contact sheet 72) to wipe away a foreign object adhered to the end face 55 of the core 5, it is possible to employ a method of washing away the foreign object adhered to the end face 55 of the core 5 by causing a liquid which has been accelerated to impact the end face 55 of the core 5. Examples of a liquid to be used include the above aprotic solvent and the liquid obtained by adding a surfactant to water. The liquid obtained by adding a surfactant to water is preferably used.

(Unevenness Inspection Step)

The unevenness inspection step S5 is a step of inspecting the core 5 in order to determine whether or not there is damage to the outer peripheral surface 54 of the core 5. As discussed above, since a cutter or the like is used when cutting the separator off from the core 5, there is the risk that there will be damage present in the outer peripheral surface 54 of the core 5 after the core has been used. In the unevenness inspection step S5, it is confirmed whether or not there is damage to the outer peripheral surface 54 of the core 5. In a case where there is damage, the damage is repaired in the damage repair step S6 which follows. This makes it possible to avoid reusing the core 5 in a state where there remains damage to the outer peripheral surface 54 thereof.

(Damage Repair Step)

The damage repair step S6 is a step of repairing damage to the outer peripheral surface 54 of the core 5. In a case where damage to the outer peripheral surface 54 is found in the unevenness inspection step S5, unevenness of the outer peripheral surface 54 caused by such damage is reduced in the damage repair step S6. This is done by smoothing the damage by use of a scraper or the like. The damage repair step S6 can be omitted in a case where no damage to the outer peripheral surface 54 of the core 5 is found in the unevenness inspection step S5.

(Whole Core Cleaning Step)

The whole core cleaning step S7 is a step of wiping the whole of the core 5 with, for example, a fabric (fiber member) moistened with a solvent. The outer cylindrical member 51, the inner cylindrical member 52, and the plurality of ribs 53 constituting the core 5 are wiped in the whole core cleaning step S7. This makes it possible to more reliably remove, from all surfaces of the core 5, any foreign object adhered thereto.

(Foreign Object Inspection Step)

The foreign object inspection step Sa is a step of inspecting the core 5 which has been cleaned in the end face cleaning step S4, in order to determine whether a foreign object is adhered to the core 5. The foreign object inspection step Sa is carried out under lighting which has a color temperature in a range from 2500 K to 7000 K and a special color rendering index R15 of not less than 60. The lighting is typically a light emitting diode (LED) but can alternatively be a fluorescent lamp, a light bulb, or the like.

Japan Industrial Standards (JIS) Z 8726:1990 (“Method of specifying color rendering properties of light sources”) prescribes the use of general color rendering indices R1 through R8 and special color rendering indices R9 through R15 as indices for specifying color rendering properties of light sources. Of these indices, the special color rendering index R15 can be described as “Japanese skin color” and is defined as having, in the Munsell color system, a hue of 1YR, a value of 6, and a chroma of 4.

With the foreign object inspection step Sa, any black electrically conductive material or white material that has adhered to the core 5 is adequately visible. As such, in a case where black electrically conductive material or white material has adhered to the core 5 as a foreign object, the foreign object inspection step Sa makes it easy to quickly find such a foreign object. With the foreign object inspection step Sa, therefore, it is possible to shorten the amount of time of an inspection step required for reuse of the core 5.

Table 1 indicates a relationship between (i) the type of lighting used in an inspection step to determine whether a foreign object is adhered to the core 5, after the core 5 has been cleaned in the end face cleaning step S4, and (ii) the ease with which dirt (a foreign object), adhered to the core 5, can be found.

In creating Table 1, tests were performed using, as the core 5, (i) a white core (5Y 9.0/2.0) having, in the Munsell color system, a hue of 5Y, a value of 9.0, and a chroma of 2.0 and (ii) a red core (5R 4.0/12.0) having, in the Munsell color system, a hue of 5R, a value of 4.0, and a chroma of 12.0. Dirt was caused to adhere to the cores 5 indicated in Table 1 in the following manner. First, a lead (length: 10 mm; thickness: [symbol] 2 mm) was removed from an HB pencil (manufactured by Mitsubishi Pencil Co., Ltd.; “Office-use pencil 9800”). The lead was set in a fastness friction testing apparatus (manufactured by Toyo Seiki Seisaku-sho, Ltd.; model D) so as to produce a mark which would measure 10 mm wide after friction testing. The lead set thusly was then rubbed onto a test piece (width: 15 mm; length 45 mm; thickness: 6 mm; made from ABS) of the core 5. Specifically, the lead was rubbed back and forth 10 times along a center portion of the test piece in a longitudinal direction using a load of 200 g. Next, the lead was replaced with a paper wipe (manufactured by Nippon Paper Crecia Co., Ltd.; “Kimwipe S-200”; 120 mm×215 mm) which had been folded in half. The paper wipe was caused to soak up ethanol (1 mL) and then rubbed back and forth once on the test piece of the core 5 using a load of 200 g. What remained of the mark from the lead was considered to be the “dirt” on the core 5.

An inspection was then carried out to determine whether or not dirt, produced under the above conditions, was adhered to the core 5. The inspection was carried out under various lighting defined by the combinations of color temperature, special color rendering index R15, and illuminance indicated in Table 1. The differences in combinations are indicated in Table 1 as Examples 1 through 4 and Comparative Examples 1 and 2. The visual noticeability of the dirt was then determined using the following criteria.

Presence of dirt is clearly noticeable: A

Presence of dirt is noticeable with careful inspection: B

Presence of dirt is difficult to determine: C

Presence of dirt is nearly impossible to determine: D

TABLE 1

| | | Special | | | |
|---|---|---|---|---|---|
| | Color | color | | Noticeability of dirt | |
| | temperature | rendering | | White core | Red core |
| | (K) | index R15 | Illuminance | (5Y 9.0/2.0) | (5R 4.0/12.0) |
| Example 1 | 2700 | 72 | 1200 | B | C |
| Example 2 | 6500 | 86 | 1200 | A | B |
| Example 3 | 2800 | 94 | 1200 | C | C |
| Example 4 | 6700 | 95 | 1200 | C | C |
| Comparative | 6500 | 56 | 1200 | D | D |
| Example 1 | | | | | |
| Comparative | 3500 | 40 | 1200 | D | D |
| Example 2 | | | | | |

From Examples 1 through 4 in Table 1, it was found that in order to determine the presence of dirt adhered to the core 5, color temperature is preferably in a range from 2500 K to 7000 K. It was further found, from Examples 1 through 4 and Comparative Example 1 in Table 1, that in order to determine the presence of dirt adhered to the core 5, the special color rendering index R15 is preferably not less than 60. It was also found, from Examples 1 through 4 in Table 1, that in order to determine the presence of dirt adhered to the core 5, the special color rendering index R15 is preferably not more than 95, and more preferably not more than 90.

Note that, although in FIG. 6, the foreign object inspection step Sa is carried out between the end face cleaning step S4 and the unevenness inspection step S5, the foreign object inspection step Sa can alternatively be carried out after the unevenness inspection step S5. Specifically, the foreign object inspection step Sa need only be carried out at least (i) between the end face cleaning step S4 and the unevenness inspection step S5, (ii) between the unevenness inspection step S5 and the damage repair step S6, (iii) between the damage repair step S6 and the whole core cleaning step S7, or (iv) after the whole core cleaning step S7.

Furthermore, in the foreign object inspection step Sa, the presence or absence of a foreign object adhered to the core 5 can be determined by a visual inspection or can alternatively be determined by an inspection using a machine, such as an optical inspection apparatus or the like.

Furthermore, an inspection to determine whether or not a foreign object is adhered to the core 5, which inspection is carried out under lighting having a color temperature in a range from 2500 K to 7000 K and a special color rendering index R15 of not less than 60 (preferably of not more than 95 and more preferably of not more than 90) is not limited to use in the foreign object inspection step Sa. That is, in a case where black electrically conductive material or white material is adhered to the core 5 as a foreign object, the above inspection makes it easy to quickly find such a foreign object, regardless of whether the inspection is carried out in the foreign object inspection step Sa. In other words, Embodiment 1 includes in its scope a method for inspecting the core 5, which method includes a step of inspecting the core 5, in order to determine whether a foreign object is adhered thereto, the inspecting being carried out under lighting having a color temperature in a range from 2500 K to 7000 K and a special color rendering index R15 of not less than 60.

As described above, a method for cleaning the core 5 in accordance with Embodiment 1 includes (i) the end face cleaning step S4 of removing a foreign object adhered to an end face 55 of the core 5 and (ii) the unevenness inspection step S5 of inspecting the core 5 in order to determine whether or not there is damage to the outer peripheral surface 54 of the core 5

In a method for cleaning the core 5 in accordance with Embodiment 1, a foreign object adhered to an end face 55 of the core 5 is removed in the end face cleaning step S4. This makes it possible to prevent a foreign object from adhering to a separator wound around the core 5 when the core 5 is reused.

Furthermore, in a method for cleaning the core 5 in accordance with Embodiment 1, the core 5 is inspected, in the unevenness inspection step S5, in order to determine whether or not there is damage to the outer peripheral surface 54 of the core 5. This makes it possible to avoid reusing the core in a state where there remains damage to the outer peripheral surface 54 thereof. This, in turn, makes it possible to prevent a separator which is to be wound around the core 5 from being damaged by unevenness due to such damage to the core 5.

As such, Embodiment 1 makes it possible to realize a method for cleaning the core 5 which can suitably prevent, in reuse of the core 5, (i) adherence of a foreign object to a separator and (ii) damage to the separator.

### Embodiment 2

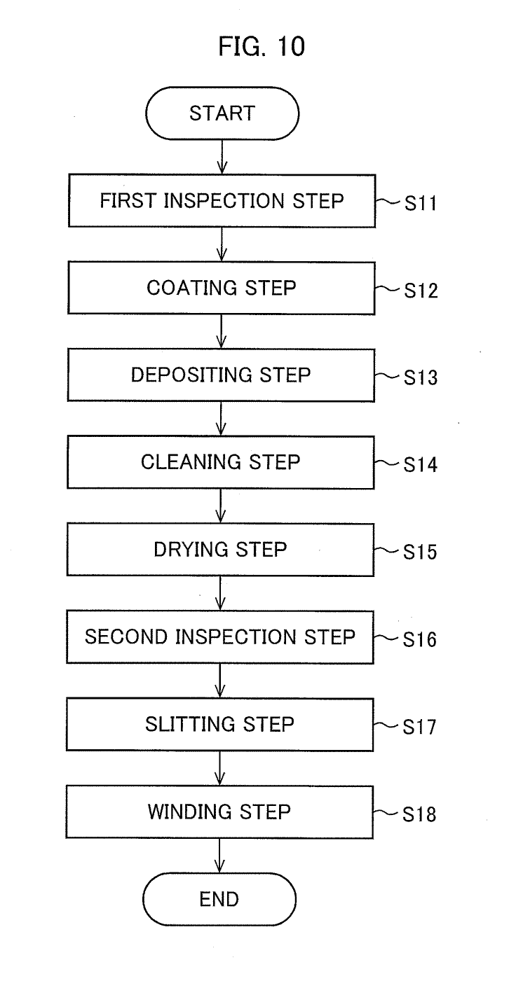

The following description will discuss another embodiment of the present invention with reference to FIG. 10. Discussed in Embodiment 2 is an example of a method for producing the separator roll 6 discussed in Embodiment 1.

<Method for Producing Separator Roll>

FIG. 10 is a flow chart schematically showing a method for producing the separator roll 6 in accordance with Embodiment 2. The heat-resistant separator 12a to be wound around the core 5 is configured to include (i) the separator 12 and (ii) the heat-resistant layer 4 disposed on the separator 12. The heat-resistant separator 12a is obtained by (i) forming the heat-resistant layer 4 on a surface of an original sheet of the separator 12 which serves as a base material, the separator 12 being transferred via a transfer system such as a roller, and (ii) subsequently slitting the separator 12, having the heat-resistant layer 4 thereon, so as to have a product width.

In the method shown exemplarily, a wholly aromatic polyamide (aramid resin) is used as a coating material which forms the heat-resistant layer 4. The method includes a step of disposing the heat-resistant layer 4 on the original sheet of the separator 12 (such an original sheet hereinafter also referred to as a “separator original sheet”).

Specifically, the method includes a first inspection step S11, a coating step S12, a depositing step S13, a cleaning step S14, a drying step S15, a second inspection step S16, a slitting step S17, and a winding step S18. Each of the steps S11 through S18 will be discussed below in order.

(First Inspection Step)

The first inspection step S11 is a step of inspecting the separator original sheet, which will serve as the base material of the heat-resistant separator 12a, in order to determine, prior to subsequent steps, whether or not there is a defect in the separator original sheet.

(Coating Step)

The coating step S12 is a step of coating, with a coating material (a material) for the heat-resistant layer 4, the separator original sheet which has been inspected in the first inspection step S11. In the coating step S12, it is possible to carry out the coating with respect to only one surface of the separator original sheet or both surfaces of the separator original sheet.

For example, in the coating step S12, the separator original sheet is coated with an aramid/NMP (N-methyl-pyrrolidone) solution, as the coating material for the heat-resistant layer 4. Note that the heat-resistant layer 4 is not limited to an aramid heat-resistant layer. For example, a mixed solution containing a filler such as alumina/carboxymethyl cellulose can be applied as the coating material for the heat-resistant layer 4.

A method for coating the separator original sheet with the coating material is not specifically limited as long as uniform wet coating can be performed with respect to the separator original sheet by the method, and various methods can be employed.

For example, it is possible to employ any of the methods such as a capillary coating method, a slit die coating method, a spray coating method, a dip coating method, a roll coating method, a screen printing method, a flexo printing method, a bar coater method, a gravure coater method, or a die coater method.

A coating material for the heat-resistant layer 4 with which material the separator original sheet is coated has a film thickness that can be controlled by adjusting a thickness of a coating wet film and a solid-content concentration in the coating solution.

(Depositing Step)

The depositing step S13 is a step of solidifying the coating material with which the separator original sheet has been coated in the coating step S12. In a case where the coating material is an aramid coating material, for example, water vapor is applied to a coated surface so that aramid is solidified by humidity deposition.

(Cleaning Step)

The cleaning step S14 is a step of cleaning the separator original sheet on which the coating material has been solidified in the depositing step S13 (such a separator original sheet hereinafter also referred to as a “heat-resistant separator original sheet”). In a case where the heat-resistant layer 4 is an aramid heat-resistant layer, for example, water, an aqueous solution, or an alcohol-based solution is suitably used as a cleaning liquid.

Note that the cleaning step S14 can be multistage cleaning in which cleaning is carried out a plurality of times in order to enhance a cleaning effect.

Moreover, after the cleaning step S14, a water removing step can be carried out for removing water from the heat-resistant separator original sheet which has been cleaned in the cleaning step S14. A purpose of the water removing is to remove water or the like that is adhered to the heat-resistant separator original sheet before the subsequent drying step S15 so that drying can be carried out more easily and insufficient drying can be prevented.

(Drying Step)

The drying step S15 is a step of drying the heat-resistant separator original sheet that has been cleaned in the cleaning step S14. A method for drying the heat-resistant separator original sheet is not particularly limited, and, for example, it is possible to use various methods such as a method in which the heat-resistant separator original sheet is brought into contact with a heated roller or a method in which hot air is blown onto the heat-resistant separator original sheet.

(Second Inspection Step)

The second inspection step S16 is a step of inspecting the heat-resistant separator original sheet which has been dried in the drying step S15. In the inspection, a defect is marked as appropriate, and it is therefore possible to effectively inhibit the heat-resistant separator original sheet from having a defect.

(Slitting Step)

The slitting step S17 is a step of slitting (cutting) the heat-resistant separator original sheet which has been inspected in the second inspection step S16 into parts each having a predetermined product width. Specifically, in the slitting step S17, the heat-resistant separator original sheet is slit into parts each having a product width which is suitable for an applied product such as the lithium-ion secondary battery 1.

As described above, in order to increase productivity, a heat-resistant separator original sheet is usually produced so as to have a width that is equal to or greater than the product width. The heat-resistant separator original sheet 12a is therefore obtained by slitting the separator original sheet, in the slitting step S17, so as to have the product width.

(Winding Step)

The winding step S18 is a step of winding the heat-resistant separator original sheet 12a, which has been slit in the slitting step S17 so as to have the product width, around the core 5 having a cylindrical shape. In Embodiment 2, the core 5 which has been cleaned via the method for cleaning as described in Embodiment 1 is reused. This makes it possible to prevent (i) adherence of a foreign object to the heat-resistant separator 12a and (ii) damage to the heat-resistant separator 12a, each of which could occur in a case where the core 5 is not cleaned after use and is reused as is. This makes it possible to prevent the occurrence of product defects, such as short-circuiting, in a lithium-ion secondary battery 1 produced using the heat-resistant separator 12a.

In this way, the method for producing the separator roll 6 in accordance with Embodiment 2 includes the winding step S18 of winding the heat-resistant separator 12a around the core 5 which has been cleaned via the method for cleaning in accordance with Embodiment 1.

As such, Embodiment 2 makes it possible produce the separator roll 6 which can prevent, in reuse of the core 5, (i) adherence of a foreign object to the heat-resistant separator 12a and (ii) damage to the heat-resistant separator 12a.

[Supplemental Remarks]

A method for cleaning a separator core in accordance with an embodiment of the present invention is a method for cleaning a separator core having an outer peripheral surface around which a nonaqueous electrolyte secondary battery separator is to be wound, the method including: an end face cleaning step of removing a foreign object adhered to an end face of the separator core.

In a separator core which has been used and from which a separator (nonaqueous electrolyte secondary battery separator) has been wound off, there are cases in which a foreign object, such as an electrically conductive foreign object, is adhered to the separator core. Such a foreign object is particularly likely to adhere to an end face of the separator core. In the above method, a foreign object adhering to an end face of the separator core is removed in an end face cleaning step. This makes it possible to prevent a foreign object from adhering to a separator wound around the separator core when the separator core is reused.

As such, with the above method, it is possible to realize a method for cleaning the separator core which can suitably prevent, in reuse of the separator core, adherence of a foreign object to a separator.

The method for cleaning a separator core in accordance with an embodiment of the present invention preferably further includes an unevenness inspection step of inspecting the separator core in order to determine whether or not there is damage to the outer peripheral surface.

Since a cutter or the like may be used when cutting a separator off from the separator core, there is the risk that there will be damage present in the outer peripheral surface of the separator core after the separator core has been used. In a case where the separator core having such damage is reused as is, unevenness caused by the damage can damage a separator wound around the separator core. This can cause a product defect such as a short circuit in a nonaqueous electrolyte secondary battery produced using the separator.

In the above method, the separator core is inspected, in the unevenness inspection step, in order to determine whether or not there is damage to the outer peripheral surface of the separator core. This makes it possible to avoid reusing the separator core in a state where there remains damage to the outer peripheral surface thereof. This, in turn, makes it possible to prevent a separator which is to be wound around the separator core from being damaged by unevenness due to such damage to the separator core.

The method for cleaning a separator core in accordance with an embodiment of the present invention preferably further includes a damage repair step of, in a case where damage to the outer peripheral surface is found in the unevenness inspection step, repairing the damage.

In the above method, damage to the outer peripheral surface of the separator core is removed in the damage repair step. This makes it possible to prevent unevenness caused by the damage from damaging a separator when the separator core is reused.

The method for cleaning a separator core in accordance with an embodiment of the present invention preferably further includes an outer peripheral surface cleaning step of removing a foreign object adhered to the outer peripheral surface.

In the above method, a foreign object adhering to the outer peripheral surface of the separator core is removed in the outer peripheral surface cleaning step. This makes it possible to prevent the foreign object adhering to the outer peripheral surface from adhering to a separator when the separator core is reused.

The method for cleaning a separator core in accordance with an embodiment of the present invention preferably further includes a whole core cleaning step of wiping a whole of the separator core with a fiber member.

In the above method, the whole of the separator core is wiped with the fiber member in the whole core cleaning step. This makes it possible to reliably remove a foreign object adhering to the separator core.

The method for cleaning a separator core in accordance with an embodiment of the present invention is preferably arranged such that, in the end face cleaning step, a pressure-contact member is pressed into contact with the end face.

With the above method, it is possible to better prevent deterioration of the separator core, in comparison to a method in which, for example, a solvent such as alcohol is used to clean an end face of the separator core.

The method for cleaning a separator core in accordance with an embodiment of the present invention is preferably arranged such that the pressure-contact member is in the form of a sheet.

The above method makes it possible to suitably remove a foreign object adhering to an end face of the separator core by scouring off the foreign object with the pressure-contact member in the form of a sheet.

The method for cleaning a separator core in accordance with an embodiment of the present invention is preferably arranged such that the pressure-contact member has asperities or a plurality of micropores.

In the above method, the pressure-contact member in the form of a sheet has asperities or a plurality of micropores. This makes it possible to increase the wiping effect of the pressure-contact member in the form of a sheet.

The method for cleaning a separator core in accordance with an embodiment of the present invention is preferably arranged such that in the end face cleaning step, a liquid which has been accelerated is caused to impact the end face.

The above method makes it possible to more easily remove a foreign object adhering to an end face of the separator core.

The method for cleaning a separator core in accordance with an embodiment of the present invention is preferably arranged such that in the end face cleaning step, the end face is treated with a solvent which is aprotic.

With the above method, it is possible to better prevent deterioration of the separator core, in comparison to a method in which, for example, alcohol is used to treat an end face of the separator core.

The method for cleaning a separator core in accordance with an embodiment of the present invention is preferably arranged such that in the end face cleaning step, the end face is treated with a liquid obtained by adding a surfactant to water.

With the above method, it is possible to better prevent deterioration of the separator core, in comparison to a method in which, for example, alcohol is used to treat an end face of the separator core.

The method for cleaning a separator core in accordance with an embodiment of the present invention preferably further includes a foreign object inspection step of inspecting the separator core which has been cleaned in the end face cleaning step, in order to determine whether or not a foreign object is adhered thereto, the inspecting being carried out under lighting having (i) a color temperature in a range from 2500 K to 7000 K and (ii) a special color rendering index R15 of not less than 60.

With the above method, black electrically conductive material or white material that has adhered to the separator core is adequately visible. As such, in a case where such black electrically conductive material or white material has adhered to the separator core as foreign object, the above method makes it easy to quickly find such a foreign object. As such, with the above method, it is possible to shorten the amount of time of an inspection step required for reuse of the separator core.

A separator roll in accordance with an embodiment of the present invention includes: a separator core which has been cleaned by the method for cleaning in accordance with an embodiment of the present invention; and a nonaqueous electrolyte secondary battery separator wound around the separator core.

The above configuration makes it possible to realize a separator roll which makes it possible to prevent, in reuse of the separator core, (i) adherence of a foreign object to a separator and (ii) damage to the separator.

A method for producing a separator roll in accordance with an embodiment of the present invention includes: a winding step of winding a nonaqueous electrolyte secondary battery separator around a separator core which has been cleaned by the method for cleaning in accordance with an embodiment of the present invention.

With the above method, it is possible to realize a method for producing a separator roll which makes it possible to prevent, in reuse of the separator core, (i) adherence of a foreign object to a separator and (ii) damage to the separator.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Lithium-ion secondary battery (nonaqueous electrolyte secondary battery)
5 Core (separator core)
6 Separator roll
12 Separator
12a Heat-resistant separator (separator)
54 Outer peripheral surface
55 End face
72 Pressure-contact sheet (pressure-contact member)
S3 Outer peripheral surface cleaning step
S4 End face cleaning step
S5 Unevenness inspection step
S6 Damage repair step
S7 Whole core cleaning step
S18 Winding step

1. A method for cleaning a separator core having an outer peripheral surface around which a nonaqueous electrolyte secondary battery separator is to be wound, the method comprising:
an end face cleaning step of removing a foreign object adhered to an end face of the separator core.

2. The method according to claim 1, further comprising:
an unevenness inspection step of inspecting the separator core in order to determine whether or not there is damage to the outer peripheral surface.

3. The method according to claim 2, further comprising:
a damage repair step of, in a case where damage to the outer peripheral surface is found in the unevenness inspection step, repairing the damage.

4. The method according to claim 1, further comprising:
an outer peripheral surface cleaning step of removing a foreign object adhered to the outer peripheral surface.

5. The method according to claim 1, further comprising:
a whole core cleaning step of wiping a whole of the separator core with a fiber member.

6. The method according to claim 1, wherein
in the end face cleaning step, a pressure-contact member is pressed into contact with the end face.

7. The method according to claim 6, wherein
the pressure-contact member is in the form of a sheet.

8. The method according to claim 7, wherein
the pressure-contact member has asperities or a plurality of micropores.

9. The method according to claim 1, wherein
in the end face cleaning step, a liquid which has been accelerated is caused to impact the end face.

10. The method according to claim 1, wherein
in the end face cleaning step, the end face is treated with a solvent which is aprotic.

11. The method according to claim 1, wherein
in the end face cleaning step, the end face is treated with a liquid obtained by adding a surfactant to water.

12. The method according to claim 1, further comprising:
a foreign object inspection step of inspecting the separator core which has been cleaned in the end face cleaning step, in order to determine whether or not a foreign object is adhered thereto, the inspecting being carried out under lighting having (i) a color temperature in a range from 2500 K to 7000 K and (ii) a special color rendering index R15 of not less than 60.

13. A separator roll comprising:
a separator core which has been cleaned by the method recited in claim 1; and
a nonaqueous electrolyte secondary battery separator wound around the separator core.

14. A method for producing a separator roll, the method comprising:
a winding step of winding a nonaqueous electrolyte secondary battery separator around a separator core which has been cleaned by the method recited in claim 1.
